(19) United States
(12) Patent Application Publication
(10) Pub. No.: US 2003/0172132 A1
(43) Pub. Date: Sep. 11, 2003

(54) Method and system for remote reception of real-time audio/video programmes

(75) Inventors: Yao-Nan Lin, Chung-Ho City (TW); Ming-Sheng Lin, Chung-Ho City (TW); Yu-Hsiang Huang, Chung-Ho City (TW)

Correspondence Address: LADAS & PARRY, 5670 Wilshire Boulevard, Los Angeles, CA, 90036-5679, US

(73) Assignee: MICRO-STAR INT'L CO., LTD.

(21) Appl. No.: 10/267,403

(22) Filed: Oct. 8, 2002

(30) Foreign Application Priority Data
Mar. 8, 2002 (TW) 091104397

(51) Int. Cl. H04N 7/173; G06F 15/16

(52) U.S. Cl. 709/219; 725/109; 725/87; 725/112

(57) ABSTRACT

In a method and system for the remote reception of real-time audio/video programmes, a receiver station establishes an Internet connection with a source station that is connected to a signal source, which provides a programme signal containing a plurality of channels of audio/video programmes. The source station is enabled to select one of the channels of the programme signal, to convert programme content of the selected one of the channels into digital programme data, to compress the digital programme data to result in compressed programme data, to convert the compressed programme data into a format suitable for transmission over the Internet, and to transmit the compressed programme data to the receiver station through the Internet.

### CROSS-REFERENCE TO RELATED APPLICATION

This application claims priority of Taiwanese Application No. 091104397, filed on Mar. 8, 2002.

### BACKGROUND OF THE INVENTION

1. Field of the Invention

The invention relates to the art of real-time programme reception, more particularly to a method and system for the remote reception of real-time audio/video programmes.

2. Description of the Related Art

Most households currently enjoy the services provided by cable television providers. Presently, such services require the presence of a wired connection to a distribution network administered by a local cable television provider. Thus, in instances when the subscriber is not at home, such as when the subscriber is not in his home country, he will not be able to receive programmes delivered to the subscriber's premises by a local cable television provider.

FIG. 1 illustrates a conventional arrangement for viewing a television programme over the Internet 13. As shown, a computer 12 connects with a web server 11 through the Internet 13 for data transmission. Television programmes are converted into files that are stored in the web server 11, and the computer 12 can be operated to download the files over the Internet 13 for viewing.

It is noted that most television programmes watched by a subscriber in his home country may not be available for downloading over the Internet. Moreover, because there is a need to convert television programmes into files, real-time reception of the television programmes is not usually the case in the conventional arrangement of FIG. 1.

### SUMMARY OF THE INVENTION

Therefore, the main object of the present invention is to provide a method and system for remote reception of real-time audio/video programmes, such as cable television programmes, television station programmes and radio station programmes.

According to one aspect of this invention, a method for remote reception of real-time audio/video programmes comprises the steps of:

a) enabling a receiver station to establish an Internet connection with a source station that is connected to a signal source which provides a programme signal containing a plurality of channels of audio/video programmes;

b) enabling the source station to select one of the channels of the programme signal;

c) enabling the source station to convert programme content of the selected one of the channels into digital programme data, and to compress the digital programme data to result in compressed programme data; and

d) enabling the source station to convert the compressed programme data into a format suitable for transmission over the Internet, and to transmit the compressed programme data to the receiver station through the Internet.

According to another aspect of this invention, a system for remote reception of real-time audio/video programmes comprises a source station and a receiver station.

The source station includes a channel selector, a first controller coupled to the channel selector, and a first transmission module coupled to the first controller. The channel selector is adapted to be connected to a signal source which provides a programme signal containing a plurality of channels of audio/video programmes. The first controller controls the channel selector to select one of the channels of the programme signal, and to convert programme content of the selected one of the channels into digital programme data. The first controller compresses the digital programme data to result in compressed programme data that is provided to the first transmission module. The first transmission module transmits the compressed programme data through the Internet after converting the compressed programme data into a format suitable for transmission over the Internet.

The receiver station includes a second transmission module, a second controller coupled to the second transmission module, and a playback module coupled to the second controller. The second transmission module is operable so as to establish an Internet connection with the first transmission module and so as to receive the compressed programme data from the first transmission module through the Internet. The second controller receives the compressed programme data from the second transmission module, and decompresses the compressed programme data. The second controller controls the playback module to reproduce the programme content of the selected one of the channels of the programme signal.

### BRIEF DESCRIPTION OF THE DRAWINGS

Other features and advantages of the present invention will become apparent in the following detailed description of the preferred embodiment with reference to the accompanying drawings, of which:

FIG. 1 illustrates a conventional arrangement for viewing a television programme over the Internet;

FIG. 2 is a block diagram illustrating the preferred embodiment of a system for the remote reception of real-time audio/video programmes according to the present invention;

FIG. 3 is a schematic diagram illustrating the system of the preferred embodiment; and

FIG. 4 is a flowchart illustrating the method for the remote reception of real-time audio/video programmes performed by the system of the preferred embodiment.

### DETAILED DESCRIPTION OF THE PREFERRED EMBODIMENT

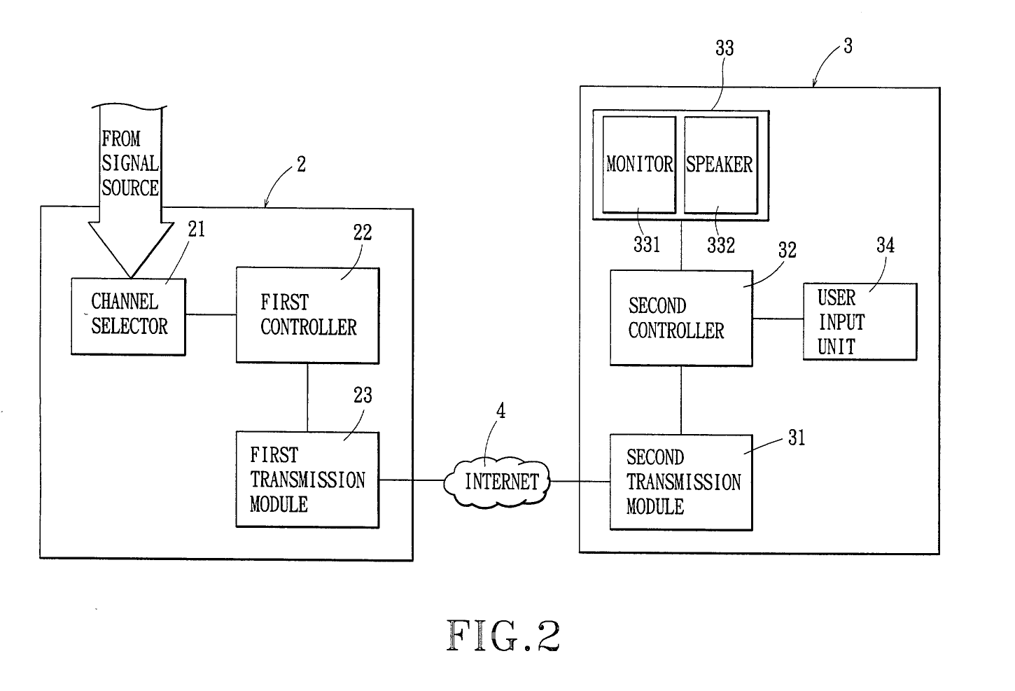

Referring to FIG. 2, the preferred embodiment of a system for the remote reception of real-time audio/video programmes according to the present invention is shown to comprise a source station 2 and a receiver station 3. The source station 2 and the receiver station 3 are disposed at two different locations, and are capable of communicating with each other over the Internet 4.

The source station 2 is adapted to be coupled to a signal source in a first location, such as Taiwan. The signal source may be a cable television signal source that provides a programme signal containing a plurality of channels of audio/video programmes, i.e., television programmes. In other embodiments, the signal source may be a wireless television receiver for receiving broadcast television signals, or a wireless radio receiver for receiving broadcast radio signals. The source station 2 is responsible for converting programme content of a selected channel of the programme signal into a standard format suitable for transmission over the Internet for reception by the receiver station 3. In this embodiment, the source station 2 includes a channel selector 21, a first controller 22 coupled to the channel selector 21, and a first transmission module 23 coupled to the first controller 22.

The channel selector 21 is adapted to make a wired or wireless connection with the signal source so as to receive the programme signal therefrom. Upon receipt of a channel select signal from the first controller 22, the channel selector 21 selects a desired channel of the programme signal, and converts programme content of the desired channel into digital programme data that is provided to the first controller 22.

The first controller 22 provides the channel select signal to the channel selector 21 in response to a channel select command that was received through the Internet 4 by the first transmission module 23 from the receiver station 3. The channel select command may be a channel forward command for advancing to a next channel in the channel sequence of the programme signal, a channel backward command for moving back to a previous channel in the channel sequence of the programme signal, or a specified channel command. The first controller 22 is also responsible for compressing the digital programme data from the channel selector 21, such as with the use of Moving Picture Experts Group 4 (MPEG4) compression technology, so as to reduce the time that is required for the first transmission module 23 to transmit the same over the Internet 4. In the preferred embodiment, the first controller 22 is capable of compressing audio data in the digital programme data according to an audio compression ratio, and video data in the digital programme data according to a video compression ratio. Each of the audio and video compression ratios may be varied in accordance with a corresponding audio compression or video compression command received by the first transmission module 23 from the receiver station 3 to suit the speed of connection over the Internet 4 and the listening and/or viewing requirements of the user of the receiver station 3. As is known in the art, a higher compression ratio results in less data to be transmitted. On the other hand, a lower compression ratio results in better sound and/or picture quality.

The first transmission module 23 is responsible for connecting with the receiver station 3 over the Internet 4. Since the source station 2 is not a web server, exchange of control commands and programme data between the first transmission module 23 and the receiver station 3 is established in a conventional manner without using the hypertext transport protocol (HTTP). The first transmission module 23 receives the channel select command and the audio and video compression commands from the receiver station 3 through the Internet 4, and provides the same to the first controller 22. The first transmission module 23 is also responsible for converting the compressed programme data from the first controller 22 into a standard format suitable for transmission over the Internet 4 to permit subsequent reception by the receiver station 3.

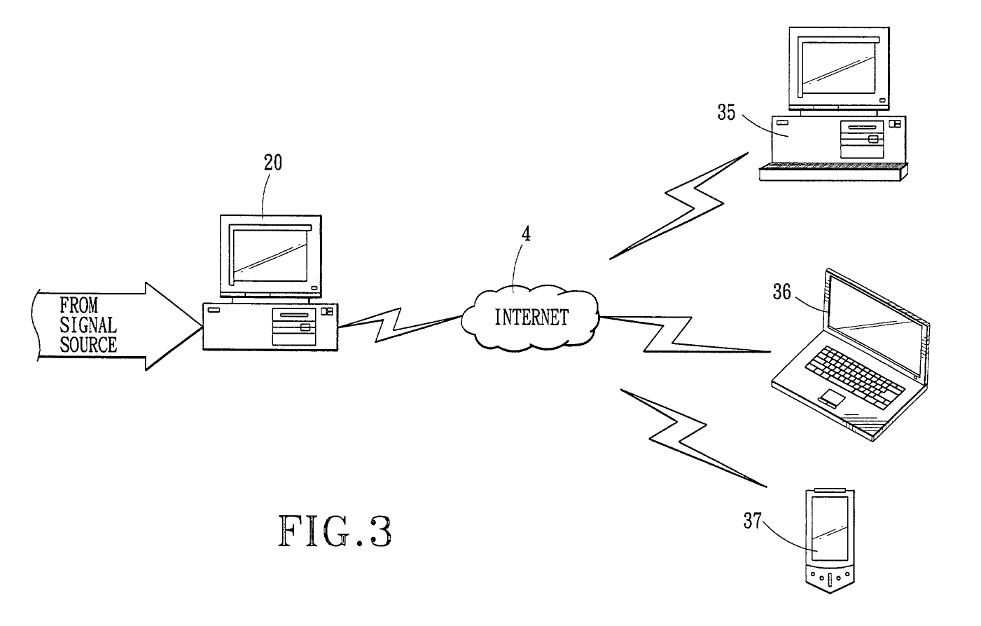

With further reference to FIG. 3, the source station 2 of this embodiment is shown to be in the form of a personal computer 20. When the personal computer 20 is loaded with an appropriate computer program product: a tuner card (not shown) of the personal computer 20 can be configured to act as the channel selector 21 for receiving the programme signal, selecting one of the channels of the programme signal, and converting programme content of the selected channel into digital programme data; a motherboard (not shown) of the personal computer 20 can be configured to act as the first controller 22 for compressing the digital programme data; and a network card (not shown) of the personal computer 20 can be configured to act as the first transmission module 23 for establishing an Internet connection with the remote receiver 3 and for transmitting the compressed programme data from the first controller 22 through the Internet 4 for reception by the remote receiver 3 after converting the compressed programme data into a format suitable for transmission over the Internet 4. In an alternative embodiment, the source station 2 may be implemented as a dedicated set-top box that includes the aforesaid components 21 to 23.

Referring once again to FIGS. 2 and 3, the receiver station 3 is adapted to be disposed in a second location, such as the United States, and is adapted to connect with the source station 2 through the Internet 4 so as to receive the compressed programme data from the source station 2. The receiver station 3 is further adapted to decompress and reproduce the programme data from the source station 2 to permit listening and/or viewing of the same by the user of the receiver station 3. In this embodiment, the receiver station 3 includes a second transmission module 31, a second controller 32 coupled to the second transmission module 31, a playback module 33 coupled to the second controller 32, and a user input unit 34 coupled to the second controller 32.

The second transmission module 31 is responsible for connecting the receiver station 3 to the source station 2 through the Internet 4 without using the hypertext transfer protocol (HTTP). Thus, the channel select command and the audio and video compression commands are provided by the receiver station 3 to the source station 2 through the second transmission module 31, and the compressed programme data is received by the receiver station 3 from the source station 2 through the second transmission module 31.

The second controller 32 is responsible for controlling the operations of the various components of the receiver station 3, and is provided with a data decompression capability corresponding to the data compression capability of the first controller 22 of the source station 2. The second controller 32 receives the compressed programme data from the second transmission module 31, and decompresses the same, such as with the use of Moving Picture Experts Group 4 (MPEG4) decompression technology, to recover the programme content of the desired channel of the programme signal for subsequent reproduction by the playback module 33. Since the programme content of the desired channel of the programme signal includes both audio and video information, the playback module 33 of this embodiment includes a monitor 331 controlled by the second controller 32 to show the video information thereon, and a speaker 332 controlled by the second controller 32 for reproducing the audio information.

The user input unit 34 is operated by the user of the receiver station 3 so as to enable the second controller 32 to output the channel select command and the audio and video compression commands. The user input unit 34 may be in the form of a keyboard, a computer mouse, or a touch control panel. When the user input unit 34 is operated, the second controller 32 will be enabled to generate the channel select command or one of the audio and video compression commands that is subsequently received by the source station 2 through the second transmission module 31 and the Internet 4. By means of the channel select command, the user of the receiver station 3 is able to browse all of the channels in the programme signal that is supplied to the source station 2.

As mentioned hereinbefore, the audio and video compression commands are generated in the receiver station 3 to vary the audio and video compression ratios in the source station 2 in order to suit the speed of connection over the Internet 4 and the listening and/or viewing requirements of the user of the receiver station 3. For example, when the connection speed is slow and audio data is not essential, e.g., when viewing a program related to stock market performance updates, the audio compression ratio may be increased to reduce the volume of audio data. Accordingly, when the connection speed is slow and high-quality images are not essential, e.g., when viewing a musical variety program, the video compression ratio may be increased to reduce the volume of video data. Furthermore, when the quality of program reception at the receiver station 3 is poor, the audio and/or video compression ratio may be decreased to improve the sound and/or picture quality.

Aside from the aforesaid channel select command and the audio and video compression commands, the second controller 32 may be further enabled to generate other commands, such as a record command, a time-shifting command, luminance and color contrast adjustment commands, etc., for the source station 2 through operation of the user input unit 34.

As shown in FIG. 3, the receiver station 3 of this embodiment may be implemented as a desktop computer 35, a notebook computer 36, a personal digital assistant 37, etc. When loaded with an appropriate computer program, a network card (not shown) of each of the desktop computer 35, the notebook computer 36 and the personal digital assistant 37 can be configured to act as the second transmission module 31 for establishing an Internet connection with the source station 2 so as to receive the compressed programme data therefrom, and each of the desktop computer 35, the notebook computer 36 and the personal digital assistant 37 can be configured with the second controller 32 for decompressing and controlling reproduction of the programme data and for generating the channel select command and the audio and video compression commands.

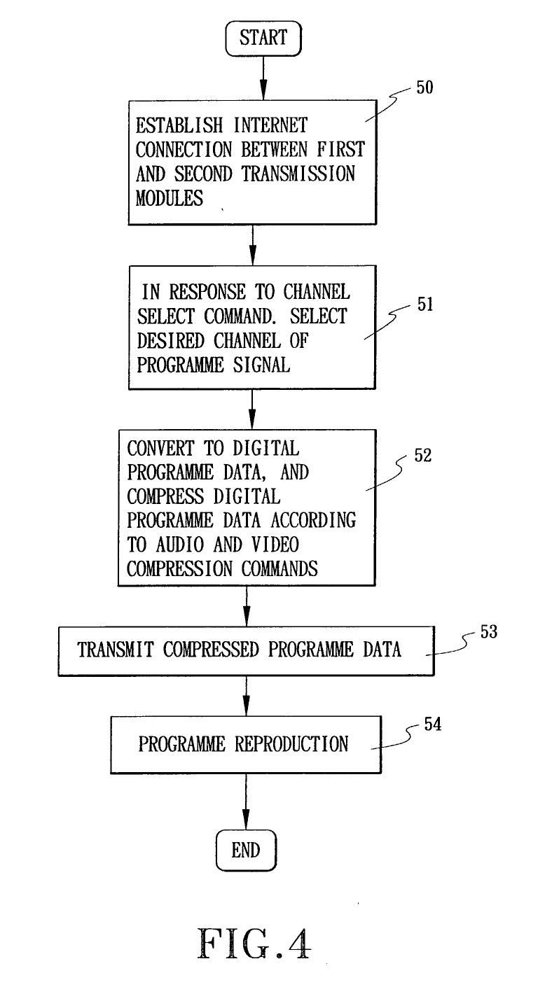

FIG. 4 is a flowchart to illustrate the method for remote reception of real-time audio/video programmes performed by the system of the preferred embodiment. Initially, at step 50, an Internet connection is established between the first and second transmission modules 23, 31. In this embodiment, the connection is made without using the hypertext transfer protocol (HTTP). Then, at step 51, in response to a channel select command that was received by the first transmission module 23 from the second transmission module 31, the first controller 22 issues a corresponding channel select signal for controlling the channel selector 21 to select a desired channel of the programme signal. Subsequently, at step 52, the channel selector 21 converts the programme content of the desired channel into digital programme data that is provided to the first controller 22, and the first controller compresses audio data of the digital programme data according to an audio compression ratio and video data of the digital programme data according to a video compression ratio. The audio and video compression ratios are set according to audio and video compression commands that were received by the first transmission module 23 from the second transmission module 31 through the Internet 4. Thereafter, at step 53, the compressed programme data is provided by the first controller 22 to the first transmission module 23, which transmits the same to the receiver station 3 through the Internet 4 after conversion into a standard format suitable for transmission over the Internet 4. Finally, at step 54, the compressed programme data is received by the second transmission module 31, is decompressed by the second controller 32, and is reproduced by the playback module 33.

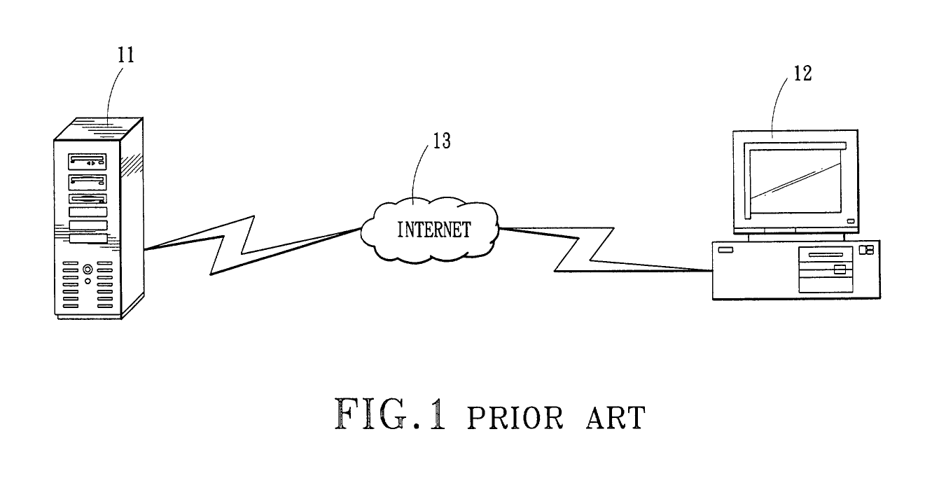

As compared to the conventional arrangement of FIG. 1, the channels of the programme signal are not converted into files that are stored in a web server in the method and system of this invention. Programme data of a selected channel of a programme signal is transmitted immediately after compression and transmission format conversion to permit remote reception of real-time audio/video programmes. Moreover, since the source station 2 is not a web server, the receiver station 3 can receive the programme data without the need to link to a website and to download files therefrom, which is a relatively slow process especially when the web server is busy.

It has thus been shown that, in the method and system of this invention, when the source station 2 is disposed at a first location, such as Taiwan, and is connected to a signal source, such as a Taiwanese cable television signal source, and when the receiver station 3 is disposed at a second location, such as the United States, interaction between the source and receiver stations 2, 3 will enable viewing at the second location of selected channels of a programme signal that was supplied to the source station 2 in real-time. Moreover, because audio and video compression ratios in the source station 2 can be controlled from the receiver station 3, the program transmission speed and the program reception quality can be varied as desired by the user of the receiver station 3.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

We claim:

1. A method for remote reception of real-time audio/video programmes, comprising the steps of:
a) enabling a receiver station to establish an Internet connection with a source station that is connected to a signal source which provides a programme signal containing a plurality of channels of audio/video programmes;
b) enabling the source station to select one of the channels of the programme signal;
c) enabling the source station to convert programme content of the selected one of the channels into digital programme data, and to compress the digital programme data to result in compressed programme data; and
d) enabling the source station to convert the compressed programme data into a format suitable for transmission over the Internet, and to transmit the compressed programme data to the receiver station through the Internet.

2. The method as claimed in claim 1, further comprising the step of:
e) enabling the receiver station to decompress and reproduce the compressed programme data from the source station.

3. The method as claimed in claim 1, wherein in step a), the Internet connection between the source station and the receiver station is established without using the hypertext transfer protocol.

4. The method as claimed in claim 1, wherein in step b), the source station selects one of the channels of the programme signal according to a channel select command transmitted by and received from the receiver station through the Internet.

5. The method as claimed in claim 1, wherein in step c), the source station compresses the digital programme data according to a compression command transmitted by and received from the receiver station through the Internet.

6. The method as claimed in claim 1, wherein in step c), the source station compresses audio data of the digital programme data according to an audio compression command transmitted by and received from the receiver station through the Internet.

7. The method as claimed in claim 1, wherein in step c), the source station compresses video data of the digital programme data according to a video compression command transmitted by and received from the receiver station through the Internet.

8. The method as claimed in claim 1, wherein the signal source to which the source station is connected is one of a cable television signal source, a wireless television receiver for receiving broadcast television signals, and a wireless radio receiver for receiving broadcast radio signals.

9. A system for remote reception of real-time audio/video programmes, comprising:
a source station including a channel selector, a first controller coupled to said channel selector, and a first transmission module coupled to said first controller,
said channel selector being adapted to be connected to a signal source which provides a programme signal containing a plurality of channels of audio/video programmes,
said first controller controlling said channel selector to select one of the channels of the programme signal, and to convert programme content of the selected one of the channels into digital programme data,
said first controller compressing the digital programme data to result in compressed programme data that is provided to said first transmission module,
said first transmission module transmitting the compressed programme data through the Internet after converting the compressed programme data into a format suitable for transmission over the Internet; and
a receiver station including a second transmission module, a second controller coupled to said second transmission module, and a playback module coupled to said second controller,
said second transmission module being operable so as to establish an Internet connection with said first transmission module and so as to receive the compressed programme data from said first transmission module through the Internet,
said second controller receiving the compressed programme data from said second transmission module and decompressing the compressed programme data,
said second controller controlling said playback module to reproduce the programme content of the selected one of the channels of the programme signal.

10. The system as claimed in claim 9, wherein said second transmission module is operable so as to establish the Internet connection with said first transmission module without using the hypertext transfer protocol.

11. The system as claimed in claim 9, wherein said receiver station further includes a user input unit coupled to said second controller and operable so as to enable said second controller to generate a channel select command that is transmitted to said first controller through said second transmission module, the Internet, and said first transmission module,
said first controller controlling said channel selector to select one of the channels of the programme signal according to the channel select command transmitted by and received from said receiver station.

12. The system as claimed in claim 9, wherein said receiver station further includes a user input unit coupled to said second controller and operable so as to enable said second controller to generate a compression command that is transmitted to said first controller through said second transmission module, the Internet, and said first transmission module,
said first controller compressing the digital programme data according to the compression command transmitted by and received from said receiver station.

13. The system as claimed in claim 12, wherein the compression command includes an audio compression command, and said first controller compresses audio data of the digital programme data according to the audio compression command.

14. The system as claimed in claim 12, wherein the compression command includes a video compression command, and said first controller compresses video data of the digital programme data according to the video compression command.

15. The system as claimed in claim 9, wherein the signal source to which said channel selector is connected is one of a cable television signal source, a wireless television receiver for receiving broadcast television signals, and a wireless radio receiver for receiving broadcast radio signals.

16. The system as claimed in claim 9, wherein said playback module includes a monitor for showing video information and a speaker for reproducing audio information.

17. The system as claimed in claim 9, wherein at least one of said first and second transmission modules includes a network card.

18. The system as claimed in claim 9, wherein said channel selector includes a tuner card.

19. The system as claimed in claim 9, wherein said source station is a computer.

20. The system as claimed in claim 9, wherein said receiver station is one of a desktop computer, a notebook computer, and a personal digital assistant.

21. A source station capable of transmitting real-time audio/video programmes, comprising:
a channel selector adapted to be connected to a signal source which provides a programme signal containing a plurality of channels of audio/video programmes;
a controller coupled to said channel selector, said controller controlling said channel selector to select one of the channels of the programme signal, and to convert programme content of the selected one of the channels into digital programme data, said first controller compressing the digital programme data to result in compressed programme data; and
a transmission module coupled to said controller, said transmission module receiving the compressed programme data from said controller, said transmission module being adapted to connect to a remote receiver station through the Internet, and transmitting the compressed programme data through the Internet for reception by the remote receiver station after converting the compressed programme data into a format suitable for transmission over the Internet.

22. The source station as claimed in claim 21, wherein connection between said transmission module and the remote receiver station is established without using the hypertext transfer protocol.

23. The source station as claimed in claim 21, wherein said controller controls said channel selector to select one of the channels of the programme signal according to a channel select command received by said transmission module from the remote receiver station.

24. The source station as claimed in claim 21, wherein said controller compresses the digital programme data according to a compression command received by said transmission module from the remote receiver station.

25. The source station as claimed in claim 24, wherein the compression command includes an audio compression command, and said controller compresses audio data of the digital programme data according to the audio compression command.

26. The source station as claimed in claim 24, wherein the compression command includes a video compression command, and said controller compresses video data of the digital programme data according to the video compression command.

27. The source station as claimed in claim 21, wherein the signal source to which said channel selector is connected is one of a cable television signal source, a wireless television receiver for receiving broadcast television signals, and a wireless radio receiver for receiving broadcast radio signals.

28. The source station as claimed in claim 21, wherein said transmission module includes a network card.

29. The source station as claimed in claim 21, wherein said channel selector includes a tuner card.

30. A source station capable of transmitting real-time audio/video programmes, comprising:
receiving means for receiving a programme signal that contains a plurality of channels of audio/video programmes;
selecting means for selecting one of the channels of the programme signal;
digital converting means for converting programme content of the selected one of the channels into digital programme data;
compressing means for compressing the digital programme data to result in compressed programme data; and
transmitting means for establishing an Internet connection with a remote receiver station and for transmitting the compressed programme data through the Internet for reception by the remote receiver station after converting the compressed programme data into a format suitable for transmission over the Internet.

31. The source station as claimed in claim 30, wherein connection between said transmitting means and the remote receiver station is established without using the hypertext transfer protocol.

32. The source station as claimed in claim 30, wherein said selecting means selects one of the channels of the programme signal according to a channel select command received by said transmitting means from the remote receiver station through the Internet.

33. The source station as claimed in claim 30, wherein said compressing means compresses the digital programme data according to a compression command received by said transmitting means from the remote receiver station through the Internet.

34. The source station as claimed in claim 33, wherein the compression command includes an audio compression command, and said compressing means compresses audio data of the digital programme data according to the audio compression command.

35. The source station as claimed in claim 33, wherein the compression command includes a video compression command, and said compressing means compresses video data of the digital programme data according to the video compression command.

36. The source station as claimed in claim 30, wherein said receiving means receives the programme signal from one of a cable television signal source, a wireless television receiver for receiving broadcast television signals, and a wireless radio receiver for receiving broadcast radio signals.

37. A method for transmitting real-time audio/video programmes, comprising the steps of:
a) receiving a programme signal containing a plurality of channels of audio/video programmes;
b) selecting one of the channels of the programme signal;
c) converting programme content of the selected one of the channels into digital programme data;
d) compressing the digital programme data to result in compressed programme data; and
e) establishing an Internet connection with a remote receiver station, and transmitting the compressed programme data through the Internet for reception by the remote receiver station after converting the compressed programme data into a format suitable for transmission over the Internet.

38. The method as claimed in claim 37, wherein in step e), the Internet connection is established without using the hypertext transfer protocol.

39. The method as claimed in claim 37, wherein in step b), said one of the channels of the programme signal is selected according to a channel select command received from the remote receiver station through the Internet connection.

40. The method as claimed in claim 37, wherein in step d), the digital programme data is compressed according to a compression command received from the remote receiver station through the Internet connection.

41. The method as claimed in claim 40, wherein the compression command includes an audio compression command, and audio data of the digital programme data is compressed according to the audio compression command.

42. The method as claimed in claim 40, wherein the compression command includes a video compression command, and video data of the digital programme data is compressed according to the video compression command.

43. The method as claimed in claim 37, wherein in step a), the programme signal is received from one of a cable television signal source, a wireless television receiver for receiving broadcast television signals, and a wireless radio receiver for receiving broadcast radio signals.

44. A computer program product for causing a computer to perform steps for transmitting real-time audio/video programmes, the steps comprising:
a) receiving a programme signal containing a plurality of channels of audio/video programmes;
b) selecting one of the channels of the programme signal;
c) converting programme content of the selected one of the channels into digital programme data;
d) compressing the digital programme data to result in compressed programme data; and
e) establishing an Internet connection with a remote receiver station, and transmitting the compressed programme data through the Internet for reception by the remote receiver station after converting the compressed programme data into a format suitable for transmission over the Internet.

45. The computer program product as claimed in claim 44, wherein in step e), the Internet connection is established without using the hypertext transfer protocol.

46. The computer program product as claimed in claim 44, wherein in step b), said one of the channels of the programme signal is selected according to a channel select command received from the remote receiver station through the Internet connection.

47. The computer program product as claimed in claim 44, wherein in step d), the digital programme data is compressed according to a compression command received from the remote receiver station through the Internet connection.

48. The computer program product as claimed in claim 47, wherein the compression command includes an audio compression command, and audio data of the digital programme data is compressed according to the audio compression command.

49. The computer program product as claimed in claim 47, wherein the compression command includes a video compression command, and video data of the digital programme data is compressed according to the video compression command.

50. The computer program product as claimed in claim 44, wherein in step a), the programme signal is received from one of a cable television signal source, a wireless television receiver for receiving broadcast television signals, and a wireless radio receiver for receiving broadcast radio signals.

51. A receiver station capable of remote reception of real-time audio/video programmes, comprising:
a transmission module operable so as to establish an Internet connection with a remote source station for receiving compressed programme data therefrom through the Internet;
a controller coupled to said transmission module, said controller receiving the compressed programme data from said transmission module and decompressing the compressed programme data;
a playback module coupled to and controlled by said controller to reproduce the programme data; and
a user input unit coupled to said controller and operable so as to enable said controller to generate a command that is transmitted to the remote source station through said transmission module and the Internet,
the command being one of a channel select command for controlling the remote source station to select a channel in a programme signal received by the remote source station, and a compression command for controlling compression ratio of the compressed programme data received from the remote source station.

52. The receiver station as claimed in claim 51, wherein connection between said transmission module and the remote source station is established without using the hypertext transfer protocol.

53. The receiver station as claimed in claim 51, wherein the channel select command controls the remote source station to select the channel in the programme signal received by the remote source station from one of a cable television signal source, a wireless television receiver for receiving broadcast television signals, and a wireless radio receiver for receiving broadcast radio signals.

54. The receiver station as claimed in claim 51, wherein the compression command is one of an audio compression command for controlling the compression ratio of audio data, and a video compression command for controlling the compression ratio of video data.

55. The receiver station as claimed in claim 51, wherein said playback module includes a monitor for showing video information and a speaker for reproducing audio information.

56. The receiver station as claimed in claim 51, wherein said transmission module includes a network card.

57. A receiver station capable of remote reception of real-time audio/video programmes, comprising:
transmitting means for establishing an Internet connection with a remote source station and for receiving compressed programme data from the remote source station through the Internet;
decompressing means for decompressing the compressed programme data;
playback means for reproducing the programme data; and
command means for generating a command that is transmitted to the remote source station through the Internet, the command being one of a channel select command for controlling the remote source station to select a channel in a programme signal received by the remote source station, and a compression command for controlling compression ratio of the compressed programme data received from the remote source station.

58. The receiver station as claimed in claim 57, wherein connection between said transmitting means and the remote source station is established without using the hypertext transfer protocol.

59. The receiver station as claimed in claim 57, wherein the channel select command controls the remote source station to select the channel in the programme signal received by the remote source station from one of a cable television signal source, a wireless television receiver for receiving broadcast television signals, and a wireless radio receiver for receiving broadcast radio signals.

60. The receiver station as claimed in claim 57, wherein the compression command is one of an audio compression command for controlling the compression ratio of audio data, and a video compression command for controlling the compression ratio of video data.

61. A method for remote reception of real-time audio/video programmes, comprising the steps of:
a) establishing an Internet connection with a remote source station, and receiving compressed programme data from the remote source station through the Internet;
b) decompressing the compressed programme data;
c) reproducing the programme data; and
d) generating a command that is transmitted to the remote source station through the Internet, the command being one of a channel select command for controlling the remote source station to select a channel in a programme signal received by the remote source station, and a compression command for controlling compression ratio of the compressed programme data received from the remote source station.

62. The method as claimed in claim 60, wherein in step a), the Internet connection is established without using the hypertext transfer protocol.

63. The method as claimed in claim 60, wherein the channel select command controls the remote source station to select the channel in the programme signal received by the remote source station from one of a cable television signal source, a wireless television receiver for receiving broadcast television signals, and a wireless radio receiver for receiving broadcast radio signals.

64. The method as claimed in claim 60, wherein the compression command is one of an audio compression command for controlling the compression ratio of audio data, and a video compression command for controlling the compression ratio of video data.

65. A computer program product for causing a computer to perform steps for reception of real-time audio/video programmes, the steps comprising:
a) establishing an Internet connection with a remote source station, and receiving compressed programme data from the remote source station through the Internet;
b) decompressing the compressed programme data;
c) reproducing the programme data; and
d) generating a command that is transmitted to the remote source station through the Internet, the command being one of a channel select command for controlling the remote source station to select a channel in a programme signal received by the remote source station, and a compression command for controlling compression ratio of the compressed programme data received from the remote source station.

66. The computer program product as claimed in claim 65, wherein in step a), the Internet connection is established without using the hypertext transfer protocol.

67. The computer program product as claimed in claim 65, wherein the channel select command controls the remote source station to select the channel in the programme signal received by the remote source station from one of a cable television signal source, a wireless television receiver for receiving broadcast television signals, and a wireless radio receiver for receiving broadcast radio signals.

68. The computer program product as claimed in claim 65, wherein the compression command is one of an audio compression command for controlling the compression ratio of audio data, and a video compression command for controlling the compression ratio of video data.
